(19) United States
(12) Patent Application Publication
(10) Pub. No.: US 2005/0289227 A1
(43) Pub. Date: Dec. 29, 2005

(54) Method of editing a new interface of a portable device by using a browser

(75) Inventors: Cheng-Shing Lai, Taipei (TW); Xiao-Long Fan, Nankng (CN); Ai-Lin Shen, Nankng (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei (TW)

(21) Appl. No.: 11/147,277

(22) Filed: Jun. 8, 2005

(30) Foreign Application Priority Data
Jun. 29, 2004 (TW) 093119010

(51) Int. Cl. G06F 15/16; G06F 13/24

(52) U.S. Cl. 709/217; 710/266

(57) ABSTRACT

The present invention is to provide a method of editing a new interface of a portable electronic device by using a browser in which the new interface is edited with texts and graphs provided on a website associated with a server, which comprises the steps of enabling the portable electronic device to access the Internet and to login the website associated with the server; inputting and editing texts and graphs provided on the website associated with the server through a browser so as to edit a picture frame of the new interface; and downloading the edited interface to a specific folder in the portable electronic device to replace an original interface thereof.

### FIELD OF INVENTION

The invention relates to a portable electronic device, more particularly to a method of editing a new interface of a portable electronic device by using a browser so that a user may on line update a picture frame of the operating interface at any time

### BACKGROUND OF THE INVENTION

With support and facilitation from highly developed information technology and electronic industry, various high-tech products, wireless communications products and telecommunication network technologies have been greatly improved. To adapt to the market's demands, these high-tech products and wireless communications products have been manufactured with a more and more miniature volume and slight weight. Since these products are provided with satisfactory functions and have gradually reduced prices, they have been widely used and favorable to users, particularly mobile phones. The mobile phones and other wireless communications products have equivalently shortened distance among people both in time and space. However, these products have been imposed more and more critical demands for available functions provided. Therefore, whether more convenient and efficient functions and services may be provided has become an important issue for these products in seeking and being granted a higher rate.

However, the current wireless communications products only provide inflexible operating interfaces, which are dull to the users after a long use. In this regard, there is a need to provide a method of updating a picture frame of an interface as desired by a user so that the user may form a personal style abounded interface on the portable electronic device.

### SUMMARY OF THE INVENTION

In view of the above mentioned disadvantages encountered in the prior art that operating interfaces of the wireless communications products may not be changed, the Inventors have made continued researches, experiments and modifications with respect to the wireless communications products based on the previously accumulated manufacturing experiences and techniques and finally developed and devised a method of editing a new interface of a portable electronic device interface by using a browser, which may substantially address the problem faced in the prior art.

It is an object of the present invention to provide a method of editing a new interface of a portable electronic device by using a browser so that a user may on line update a picture frame of the operating interface at any time.

To achieve the above object, the method of editing a new interface of a portable electronic device (e.g. mobile phone, Personal Digital Assistant abbreviated as PDA) by using a browser according to the present invention comprises the steps of

enabling the portable electronic device to access the Internet by inputting a first instruction and to login the website associated with the server by inputting a second instruction;

inputting and editing texts and graphs provided on the website through a browser so as to edit a picture frame of the new interface as desired; and

downloading the edited interface to a specific folder in the portable electronic device.

It is another object of the present invention to provide a method of editing a new interface of a portable electronic device by using a browser so that a picture frame of a new interface may be loaded.

To achieve the above object, the method of editing a new interface of a portable electronic device by using a browser according to the present invention comprises the steps of loading information associated with the new interface, transferring the information associated with the new interface into identifiable data, rebooting the portable electronic device to reload the data and displaying a picture frame of the new interface.

The above and other objects, features and advantages of the present invention will become apparent from the following detailed description taken with the accompanying drawings.

### BRIEF DESCRIPTION OF THE DRAWINGS

FIG. 1 shows an architecture on which a method of editing a portable electronic interface by using a browser according to the present invention;

FIG. 2 shows a flowchart illustrating a first part of the method of editing a portable electronic interface by using a browser according to the present invention; and

FIG. 3 shows a flowchart illustrating a second part of the method of editing a portable electronic interface by using a browser according to the present invention.

### DETAILED DESCRIPTION OF THE PREFERRED EMBODIMENTS

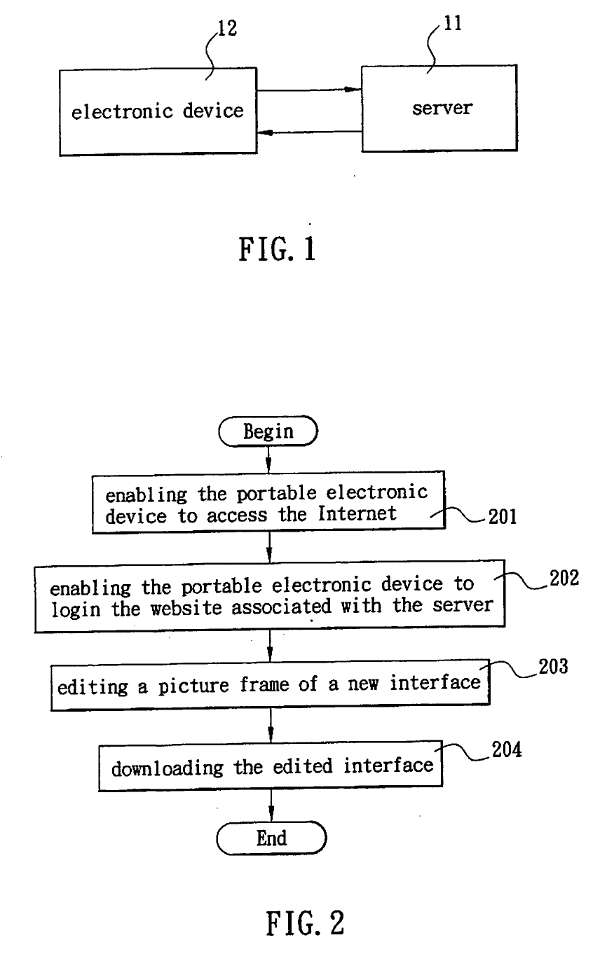

The present invention discloses a method of editing a new interface of a portable electronic device by using a browser. Referring to FIG. 1, texts and graphs for editing the new interface is stored in a website associated with a server 11. In editing the new interface, the portable electronic device (e.g. a mobile phone and a personal digital assistant (PDA)) 12 is first electronically connected to the server 11 through network system such as the Internet. Next, a user of the portable electronic device 12 makes a registration on the website associated with the server 11. Then, the user operates or manipulates the texts and graphs to edit a picture frame of the new interface. When the picture frame is completely edited, the new interface is downloaded to the electronic device 12 at a specific folder so that the original interface may be replaced.

As such, the user may on line edit the new operating interface of the portable electronic device as desired at any time so that the original operating interface may be updated.

Referring to FIG. 1 and FIG. 2, when editing the new interface, the following steps are performed with the electronic device 12. (201) First, enabling the portable electronic device 12 to access the Internet;

(202) Next, enabling the portable electronic device to login the website associated with the server 11;

(203) Then, inputting and editing texts and graphs provided on the website associated with the server 11 through a browser so as to edit a picture frame of the new interface (the sever automatically records the modified data and transforms the recorded data into information acceptable by the electronic device 12, correspondingly);

(204) Finally, downloading the edited interface to a specific folder in the electronic device 12. As such, the method is completed.

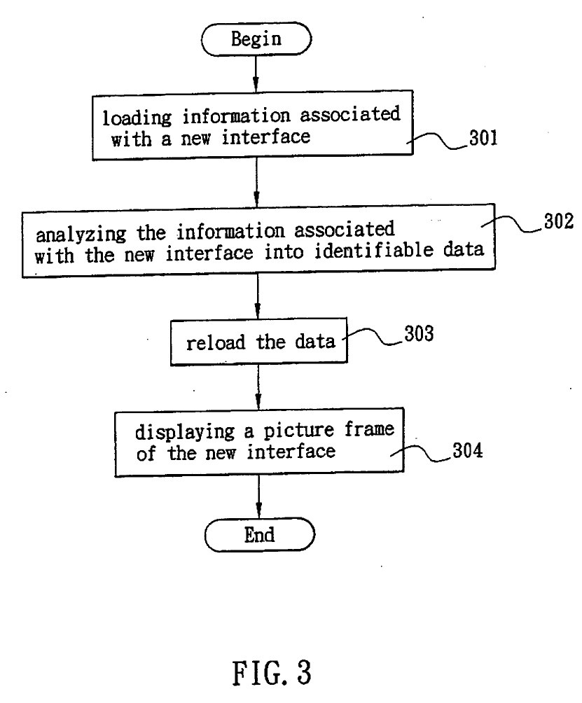

Referring to FIG. 1 and FIG. 3, when the new interface is to be loaded, the electronic device 12 performs the following steps:

(301) First, loading information associated with the new interface;

(302) Next, transferring the information associated with the new interface into identifiable data;

(303) Then, rebooting the portable electronic device to reload the data;

(304) Finally, displaying a picture frame of the new interface.

Referring again to FIG. 1 and FIG. 2, the portable electronic device 12 may be connected to the Internet through general packet radio service (GPRS) technology and then make a registration on the website associated with the server 11.

Referring to FIG. 1 and FIG. 2, after the registration is made successfully the electronic device 12 may manipulate or operate the texts and graphs provided on the website associated with the server 11 by using a specific software in the browser. As such, the picture frame of the new interface may be edited.

In light of the above description, the user of the portable electronic device 12 may update a picture frame of a new interface thereof as desired so that the user may form a personal style abounded interface.

While the invention herein disclosed has been described by means of specific embodiments, numerous modifications and variations could be made thereto by those skilled in the art without departing from the scope and spirit of the invention set forth in the claims.

1. A method of editing a new interface of a portable electronic device by using a browser in which the new interface is edited with texts and graphs provided on a website associated with a server, comprising the steps of:
enabling the portable electronic device to access the Internet and to login the website associated with the server;
inputting and editing texts and graphs provided on the website associated with the server through a browser so as to edit a picture frame of the new interface; and
downloading the edited interface to a specific folder in the portable electronic device to replace an original interface thereof.

2. The method as recited in claim 1, wherein the portable electronic device is connected to the Internet by using of general packet radio service (GPRS) technology.

3. The method as recited in claim 1, wherein the portable electronic device is a mobile phone.

4. The method as recited in claim 1, wherein the portable electronic device is a personal digital assistant (PDA).
